(19) United States
(12) Patent Application Publication
(10) Pub. No.: US 2008/0195609 A1
(43) Pub. Date: Aug. 14, 2008

(54) Method and System for Generating a Population Representative of a Set of Users of a Communication Network

(75) Inventor: Sunny Paris, Paris (FR)

Correspondence Address: PAULEY PETERSEN & ERICKSON, 2800 WEST HIGGINS ROAD, SUITE 365, HOFFMAN ESTATES, IL, 60195, US

(73) Assignee: WEBORAMA, Paris (FR)

(21) Appl. No.: 11/587,257

(22) PCT Filed: Apr. 20, 2005
(86) PCT No.: PCT/IB05/01440

§ 371 Date: Oct. 5, 2007

(30) Foreign Application Priority Data
Apr. 22, 2004 (FR) 0404271

(51) Int. Cl. G06F 17/30

(52) U.S. Cl. 707/6; 707/E17.014

(57) ABSTRACT

This invention relates to a method of generating a population representative of the behaviour of a set of users of a communication network, starting from a reference population composed of known network users listed in a database, characterised in that it comprises steps consisting of: or each site or part of site (s) in a set of sites of interest accessible through the network, determining the number of users (N(s)) who connected to the said site or part of site (s) during a given time period (T), using a traffic analysis system connected to the network for analysing traffic on sites of interest; or each site or part of site determining theoretical number (\tilde{q}(s)) of users such that the ratio between this theoretical number (\tilde{q}(s)) of users and the number of users (N(s)) who connected to the said site (s) during the given time period (T) is uniform on all sites of interest; sing processing means connected to the database to generate a population of known network users starting from the reference population so as, to minimize the difference between the said theoretical number of users

The application field of this invention is the study of behavioural profiles of Internet users or users of any other communication network.

The invention more particularly relates to a method and system for assuring that a known and qualified user population is representative.

Internet service providers, including governing bodies, advertisers, e-traders, software publishers and more generally multimedia content distributors, would like to dynamically adapt the multimedia contents that they offer as a function of the profile of each Internet user in order to optimise their efficiency. For example, they would like to be able to display advertising banners to suit the profile of each Internet user who visits a site or to highlight different products depending on the type of Internet user.

Methods for determining the profile of an unknown Internet user (or profiling methods) are known that usually use a database containing information about known Internet users who are members of a so-called reference population.

Document WO 02/33626 provides an example of such a profiling method according to which a reference population made up of Internet users with known socio-demographic profiles is used to determine sets of discriminating URL addresses for a set of attributes (for example including age or sex). These sets of URL addresses thus determined can then be used to determine a score associated with each attribute for an unknown Internet user, this score being calculated as a function of the URL addresses that the unknown Internet user has viewed.

In general, the reference population includes volunteer Internet users who agree to provide profile information concerning them (for example such as age, sex, socio-professional category, centres of interest, family situation, etc.).

This reference population is thus qualified in that each of its members are associated with profile data.

For example, these Internet users may be recruited by telephone according to socio-demographic criteria considered to be representative of a global population (for example the population of Internet users in a country). A spyware and a cookie (or connection standard) may then be installed on the browsing station of each member of the reference Internet user population.

The cookie contains Internet user identification information.

The function of the spyware is to, record browsing done by the Internet user, in other words the different sites or parts of sites that he also visits over a period of time. The spyware regularly transmits information about the browsing history of members of the reference population to a profiling system.

Note that it is also possible to ask users questions while they are browsing, so as to obtain socio-demographic type information concerning them.

Depending on the different websites visited by members of the reference population, the profiling system is then capable of statistically determining the profile of unknown Internet users who connect to a particular site of interest.

It will clearly be understood that high quality profiling is impossible unless there is a sufficiently large and statistically representative population of a set of qualified Internet users available (for example French Internet users, or Internet users using a browser in French, or Internet users connecting at night, etc.).

Representativeness assures that the behaviour of a known Internet user will correspond to the behaviour of unknown Internet users supposed to be represented by the known Internet user.

It is understandable that it is relatively easy to build up a qualified population, for example by asking Internet users questions while they are browsing or having them install software on their computer as mentioned earlier.

However, it is much more difficult to assure that the population concerned is representative.

There is a difference between the reference population composed of volunteer Internet users and the real population that it is supposed to represent.

Note that a population representing one Internet user out of n Internet users may be considered as being representative if, on average, one Internet user in this representative population makes one visit out of n visits to each site in a set of sites of interest.

In other words, on average, the percentage of user members of the representative population among the set of represented users who visited the site during a given time period is uniform on all sites of interest considered.

One purpose of the invention is to build up a representative population starting from any qualified population.

More specifically, another purpose of the invention is to assure that a reference population is representative starting from this single reference population, in particular without needing to do a framework study or to make use of profile data related to known users in the reference population.

To achieve this, according to a first aspect of the invention, the invention describes a method of generating a population representative of the behaviour of a set of users of a communication network starting from a reference population composed of known network users listed in a database, characterised in that it comprises steps consisting of:
for each site or part of a site in a set of sites of interest accessible through the network, determining the number of users (N(s)) who connected to the said site or part of site (s) during a given time period (T), using a traffic analysis system connected to the network for analysing traffic on sites of interest;
for each site or part of site (s), determining a theoretical number (\tilde{q}(s)) of users such that the ratio between this theoretical number (\tilde{q}(s) of users and the number of users (N(s)) who connected to the said site (s) during the given time period (T) is uniform on all sites of interest;
using processing means connected to the database to generate a population of known, network users starting from the reference population so as to minimize the difference between the said theoretical number of users (\tilde{q}(s)) and the number of users (qₙ(s)) in the generated population who connected to the site (s) during the time period (T), on all sites or parts of site (s).

Note that the expression “part of sites” in this description means a page or a group of pages belonging to the same site and forming a thematic entity for application of the method.

The following aspects are preferred but non-limitative aspects of the method according to the first aspect of the invention:
weighting is associated with each known user in the reference population, during the step to generate the population of known network users starting from the reference population;
the step to generate the population is performed iteratively as follows:
the weightings associated with users in the reference population are varied during each iteration;
for each iteration, the weightings thus varied are used to generate a new population starting from the reference population;
and for each iteration, on all site (s) or parts of site (s), the difference between the said theoretical number (\tilde{q}(s)) of users and the number (qₙ(s)) of users in the new population thus generated who connected to the site (s) during the time period (T), is determined; the iterations being continued until the said difference is less than a given threshold, the population generated during the last iteration being considered to be representative of the behaviour of the said set of users.
during each iteration, the new generated population is a sub-population of the reference population obtained by a random draw of users in the reference population in which the probability of drawing each user in the reference population is equal to the weighting associated with him, each Internet user thus drawn being counted in full in the generated population.
during each iteration, the new generated population is a population with exactly the same size as the reference population in which the weight of each Internet user is equal to the weighting associated with him.
in each iteration, the weighting associated with a user in the reference population is increased if he has connected during a given time period to sites for which the number of users in the reference population who connected to it is less than the theoretical number, otherwise the weighting is reduced.
the method includes a preliminary step to filter traffic data collected by the traffic analysis system, to only consider data related to all users for which a population representative of the behaviour needs to be generated.

According to a second aspect, the invention also relates to a system for generating a population of users of a communication network representative of the behaviour of a set of network users starting from a reference population composed of known network users characterised in that it comprises:
a server that generates a representative population, is connected to the network and includes processing means connected to a database listing known users in the reference population,
a system connected to the traffic analysis network analysing traffic on sites of interest capable of determining for each site or part of site among all sites of interest accessible through the network, the total number of users who connected to the said site or part of site during a given time period, and discriminating which of these users are members of the reference population, in which the processing means are capable of:
for each site or part of site, generating a theoretical number of users such that the ratio between this theoretical number of users and the total number of users who connected to the said site during the given time period is uniform on all sites of interest,
generating a population of known network users starting from the reference population so as to minimise the difference between the said theoretical number of users and the number of users in the generated population who connected to the site during the time period, for all sites or parts of site.

According to another aspect, the invention relates to a method for determining the profile of a user of a communication network comprising a step to generate a representative population starting from a reference population using the method according to the first aspect of the invention.

According to yet another aspect, the invention relates to a system for determining the profile of a user of a communication network including a system to generate a representative population according to the second aspect of the invention.

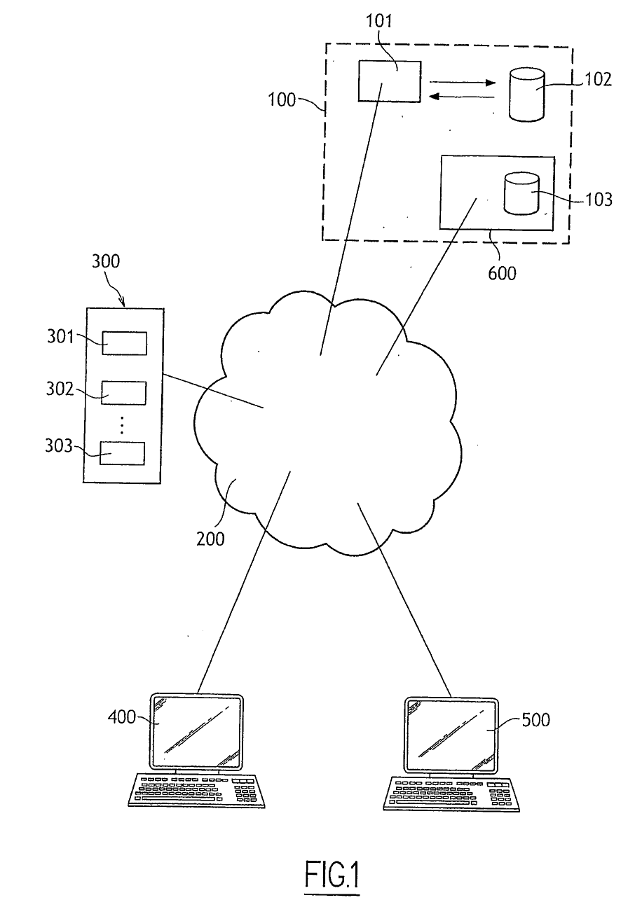

Other characteristics, purposes and advantages of the invention will become clear from the following description that is purely illustrative and is in no way limitative and should be read with reference to the single appended FIGURE. This FIG. 1 is a diagram representative of a system complying with one possible embodiment of the invention, for generating a population representative of the behaviour of a set of users of a communication network starting from a reference population composed of known users.

On the FIGURE, the system 100 that generates a representative population starting from a reference population is connected to a communication network 200 (such as Internet) to which a set 300 of Web servers of interest 301, 302, 303 is connected.

Each Web server hosts a site or multimedia contents made available to users 400, 500 of the network 200 (the Internet users) through a service provider.

The system 100 for generating a representative population includes a processing server 101 connected to the network 200 and connected to a database 102 listing information related to members of a reference Internet user population 500.

This information includes profile data about the Internet user (typically his/her age, sex, socio-professional category, etc.), and information identifying the Internet user (such as a unique identifier).

The processing server 101 includes processing means capable of generating a population representative of the behaviour of a set of Internet users who connect to Web servers' of interest 301 to 303, starting from the reference population composed of known and qualified Internet users 500 forming the reference population.

The system 100 to generate a representative population also includes a traffic analysis system 600 connected to the network 200 and provided with traffic measurement means for measuring traffic on all 300 sites of interest, and traffic data processing means.

This type of traffic analysis system 600 may for example be a page marking system according to which some pages of sites hosted by web servers 301 to 303 are marked by page markers. These markers are hosted by the traffic measurement system 600 such that when an Internet user accesses a Web page marked in this way, loading the marker will trigger sending a request to the traffic analysis system. This request informs the traffic measurement system that the Internet user is loading a given web page.

As a variant, this type of traffic analysis system 600 can also analyse log files (or connection logs) generated by Web servers 301 to 303 when an Internet user views a Web page on a site hosted by one of these servers 301 to 303.

The traffic analysis system 600 comprises a database 103 in which traffic data are recorded containing information about Internet users visiting Web pages of interest thus audited during a given period.

In particular, these traffic data include the Internet user's unique identifier, the site visited, the time of the visit, the IP address of the Internet user and his proxy, his connection speed, his time zone, languages used by his browser, and any other information that might be considered as being relevant.

The traffic analysis system 600 may also comprise means of filtering the collected traffic data so as to only consider a particular set of network users (such as French Internet users, or Internet users using a browser in the French language, or Internet users connecting at night), for which it is required to have a representative population.

The traffic analysis system 600 can also cooperate with the database 102 listing Internet users in the reference population, particularly so as to determine which of the Internet users who visited one of the sites of interest forms part of the reference population.

It is thus possible to record every connection made by an Internet user to a site during a given time period, and to discriminate which Internet users are members of the reference population.

Within the scope of the invention, there is a reference population composed of known Internet users 500 starting from which it is required to generate a representative population of a set of users 400, 500 of the network 200.

Consequently, the traffic analysis system 600 determines the number N(s) of different Internet users who visited a site or, part of site (s) within the 300 sites of interest during a given time period T.

The total number of Internet users on all sites of interest during the time period T considered is denoted N.

Obviously, according to one particular embodiment of the invention, Internet users are filtered so as to restrict the field of study to consider only Internet users in a particular population for which it is required to have a representative population (for example Internet users in a specific country, Internet users connecting at night, etc.).

As already mentioned, cooperation of the traffic analysis system 600 with the database 102 listing reference Internet users provides a means of distinguishing which of these N different Internet users form part of the reference population (the number is Q).

The proportion of known Internet users (members of the reference population) among all of the N Internet users visiting at least one site of interest during the time period T, is denoted

$$R = \frac{Q}{N} .$$

The required representativeness ratio \tilde{R} for the representative population to be generated is defined.

This ratio may be expressed using the formula \tilde{R}=

$$\frac{\tilde{Q}}{N} ,$$

in other words as being representative of the proportion of Internet users in the representative population (including \tilde{Q} Internet users) among all of the N Internet users visiting at least one site of interest during the time period T.

Note that for statistical purposes, it is obviously preferable to measure traffic on a large number of web sites of interest (for example 20 000 sites) and to have a sufficiently large reference population (for example 300 000 Internet users).

As already mentioned, a population representing one in n Internet users (representativeness ratio 1/n) may be considered as being representative if, on average, one out of n visits to each site is made by an Internet user in the said representative population.

Consequently, if a given population is representative, the ratio between the number of known users belonging to this given population who connect to each site or part of site s during the given time period T, and the total number of users who actually connect to this site, should be uniform for all sites of interest and should be equal to the representativeness ratio \tilde{R}.

Starting from the representativeness ratio \tilde{R} and the total number of users N(s) who connect to a particular site s during the time period considered, within the scope of the invention, a theoretical number \tilde{q}(s) of users is generated for each site s such that the ratio between this theoretical number \tilde{q}(s) of users and the total number of users N(s) who connected to the said site during the given time period T is uniform on all sites of interest, in other words \tilde{q}(s)=\tilde{R}*N(s).

The processing means of the server 101 used to generate a representative population are capable of generating a population of known network users starting from the reference population so as to minimise the difference between the said theoretical number \tilde{q}(s) of users and the number qₙ(s) of users in the generated population who connected to the site (s) during the time period (T), on all sites or parts of site (s).

More precisely, according to one possible embodiment of the invention, the processing means of the server 101 for generating a representative population are capable of:
determining a weighting to be associated with each known user in the reference population, and using these weightings to generate a population of known network users starting from the reference population,
and varying the weightings so as to minimize the difference between the number qₙ(s) of users in the generated population who connected to site (s) during the time period considered as determined by the traffic analysis system 600, and the theoretical number \tilde{q}(s) of users, on all sites or parts of site.

The variation of the weightings and the resulting construction of a generated population are done more precisely by iteration in order to minimise the difference between the number of expected qualified Internet users (theoretical number) and the number of Internet users actually measured.

The following gives details of one possible embodiment of such an iterative generation of a representative population.

The method is initialised firstly by associating each known Internet user in the reference population with an identical initial weighting

$${p}_{1} ( i ) = \frac{\tilde{R}}{R} .$$

During a first operation in the iteration, a sub-population of the reference population is generated by making a random draw of a number \tilde{Q}=\tilde{R}×N of Internet users among the Q Internet users in the reference population who connected to at least one of the sites of interest during the time period considered, the probability of drawing each of the Internet users in the reference population being equal to the Internet user's weighting pₙ(i) (where n denotes the rank of the iteration). Each Internet user in this sub-population is counted in full.

According to one variant of the random draw and generation of a sub-population of the reference population, the first operation in the iteration consists of generating a population with exactly the same size as the reference population of Internet users who connected to at least one of the sites of interest during the time period considered (therefore including Q members) but in which each Internet user has a particular weight equal to his weighting pₙ(i).

The second operation in the iteration is to determine the number of different Internet users in the generated population who connected during the time period considered, for each site s.

Thus, if the generated population is a sub-population of the reference population including Internet users in which each Internet user is counted in full, the qₙ(s) Internet users who connected to the site s are determined from among the Internet users. If the generated population is a population of \tilde{Q} Internet users in which the weighting of each Internet user is considered, the number qₙ(s) of different Internet users in the generated population who connected to a site during the given period is equal to the sum of weightings' of Internet users in the reference population who actually connected to the site s.

As already mentioned, the objective is to build up a generated population of known Internet users such that the proportion of Internet users in this' generated population is uniform on each site or part of site among all the sites of interest, and therefore the difference between the number qₙ(s) of Internet users in the generated population and the theoretical number \tilde{q} for all sites of interest is minimised.

The difference measurement described in the following is the variance calculation, but it will be understood that any other difference measurement could be used (for example such as the Monte Carlo method).

The third operation in the iteration consists of determining a measured value of the difference from the representativeness of the generated population, for example the variance vₙ for iteration rank n expressed by

$${v}_{n} = {\sum }_{s} {( {q}_{n} ( s ) - \tilde{q} ( s ) )}^{2} ,$$

and this difference measurement is compared with a threshold.

If the difference measurement is greater than the fixed threshold, a fourth operation in the iteration is carried out in which new weightings to be associated with each Internet user in the reference population (including Q known Internet users) are determined so as to generate a new population of known Internet users for which the difference from representativeness is reduced.

In general, the weighting associated with an Internet user in the reference population is increased if this Internet user visited sites for which the number of qualified Internet users is less than the theoretical number during the time period considered, and otherwise the weighting is reduced.

This is done by calculating a “centre of gravity” B(i) for each qualified Internet user i by summating the deviations b(s) for each site on which the Internet user i passed.

The deviation b(s) for a site s is defined as follows, depending on whether the number q(s) of known Internet users who visited the site s during the time period considered is greater than or less than the theoretical number \tilde{q}(s) of Internet users:

$$b ( s ) = \frac{{q}_{n} ( s )}{\tilde{q} ( s )} - 1 if q ( s ) \geq \tilde{q} ( s ) or b ( s ) = 1 - \frac{\tilde{q} ( s )}{{q}_{n} ( s )} if q ( s ) < \tilde{q} ( s )$$

The centre of gravity B(i) is then calculated using the expression

$$B ( i ) = {\sum }_{s ( i )} b ( s ) ,$$

where s(i) represents sites visited by Internet user i during the period considered.

The weighting pₙ(i) associated with qualified Internet user i in iteration rank n is then determined as described in the following equations:

$${p}_{n} ( i ) = {P}_{n - 1} ( i ) \frac{1}{1 + \frac{B ( i )}{{S}_{i}}} if B ( i ) \geq 0 or {P}_{n} ( i ) = {p}_{n - 1} ( i ) ( 1 - \frac{B ( i )}{{S}_{i}} ) if B ( i ) < 0 ,$$

where pₙ₋₁(i) is the weighting associated with qualified Internet user i in iteration rank n−1, and Sᵢ is the number of sites visited by Internet user i during the time period considered.

The iteration operations are restarted using these new weightings and a new population is thus generated (as described before, either by random drawing of a sub-population in which each Internet user counts in full, or by considering the reference population as a whole but in which the weighting of each Internet user is taken into account), for which the difference from representativeness is evaluated.

The iterative method described above is thus implemented until a population is generated for which the difference (in this case the variance) is less than the fixed threshold.

Note that in the context of a population generated by random drawing of a sub-population of the reference population, it is possible to make the random draw several times with the same drawing probabilities. This makes it possible to perform the operations for one iteration using several sub-populations and then in particular to make several measurements of the difference from representativeness. In particular, it is thus possible to use the sub-population with the lowest difference measurement as a basis for the calculation of new weightings for the next iteration, which undoubtedly improves the precision and speed of generation of the representative population.

Obviously, it is clear that, the representative population generated according to the invention is intended particularly for use in the context of a profiling method (and the system using the said profiling method) in which the profile of unknown Internet users is determined by comparing browsing of these unknown Internet users on sites of interest, with browsing of Internet users in the representative population.

In the context of such a profiling method, the profile of an Internet user may be composed of a series of values of attributes associated with this Internet user. The attributes consist of information associated with each Internet user, that is interesting to service providers. For example, these attributes may relate to sex, age and the socio-professional category of the Internet user.

The profile Pᵢ of a given Internet user i is expressed as a sequence including N values of attributes pᵢⱼ, where pᵢⱼ is the probability that Internet user i has attribute j.

The profile of an Internet user i may thus benoted as follows:

Pᵢ=(pᵢ₁, pᵢ₂, pᵢ₃, pᵢ₄, pᵢ₅, pᵢ₆, pᵢ₇, Pᵢ₈, pᵢ₉, pᵢ₁₀, pᵢ₁₁, pᵢ₁₂, pᵢ₁₃, . . . p_{iN}) where:
pₙ is the probability that Internet user i is a woman (j=1),
p₁₂ is the probability that Internet user i is a man (j=2)
pᵢ₃, pᵢ₄, pᵢ₅, pᵢ₆, pᵢ₇, and pᵢ₈ are probabilities that Internet user i is between 0 and 14 years old (j=3), 15 to 24 years old (j=4), 25 to 34 years old (j=5), 35 to 49 years old (j=6), 50 to 64 years old (j=7), or more than 65 years old (j=8).
pᵢ₉, pᵢ₁₀, pᵢ₁₁, pᵢ₁₂ and pᵢ₁₃ are probabilities that Internet user i belongs to specific types of socio-professional categories (j=9, 10, 11, 12 or 13),
other attributes 14 to N are also taken into account.

The profile Pₛ of a given Web site of interest s is expressed as a sequence also including N values of attributes Pₛⱼ, where Pₛⱼ is the probability that an Internet user who visits the site s has attribute j.

The profile of a site s is thus noted:

Ps=(pₛ₁, pₛ₂, pₛ₃, pₛ₄, pₛ₅, pₛ₆, pₛ₇, pₛ₈, pₛ₉, pₛ₁₀, pₛ₁₁, pₛ₁₂, pₛ₁₃, . . . p_{sN})

where the attribute values Pₛⱼ of the profile Pₛ are determined as a function of the values of attributes of Internet users in the representative population who visit site s.

For a given site of interest s, when the representative population is a sub-population of the reference population generated by a random draw in which each Internet user counts in full, the value pₛⱼ of the attribute j is the average of the values pᵢⱼ associated with Internet users in the representative population who visit the site s.

Alternately, for a given site of interest s, when the representative population is the reference population in which the weighting associated with each Internet user is taken into account, the value pₛⱼ of the attribute j is the average of the values pᵢⱼ associated with Internet users in the representative population who visit the site s, in this case these values pᵢⱼ being weighted by the weightings associated with the said Internet users.

Obviously, the invention is not limited to the particular embodiments that have just been described, but can be extended to any variant conforming with its spirit.

In particular, the invention is not limited to the generation of a representative population of Internet users, but includes the generation of a representative population of users of any type of terminal (for example computer, television, mobile telephone) connected to a communication network to enable a connection to any type of digital support (for example Wap sites, I-Mode® sites, etc.).

1. Method of generating a population representative of the behaviour of a set of users of a communication network starting from a reference population composed of known network users listed in a database, characterised in that it comprises steps consisting of:
for each site or part of site (s) in a set of sites of interest accessible through the network, determining the number of users (N(s)) who connected to the said site or part of site (s) during a given time period (T), using a traffic analysis system connected to the network for analysing traffic on sites of interest;
for each site or part of site (s), determining a theoretical number (\tilde{q}(s)) of users such that the ratio between this theoretical number (\tilde{q}(s)) of users and the number of users (N(s)) who connected to the said site (s) during the given time period (T) is uniform on all sites of interest;
using processing means connected to the database to generate a population of known network users starting from the reference population so as to minimize the difference between the said theoretical number of users (\tilde{q}(s)) and the number of users (qₙ(s)) in the generated population who connected to the site (s) during the time period (T), on all sites or parts of site (s).

2. Method according to claim 1, characterised in that weighting is associated with each known user in the reference population, during the step to generate the population of known network users starting from the reference population.

3. Method according to claim 2, characterised in that the step to generate the population is performed iteratively as follows:
the weightings associated with users in the reference population are varied during each iteration;
for each iteration, the weightings thus varied are used to generate a new population starting from the reference population,
and for each iteration, on all site (s) or parts of site (s), the difference between the said theoretical number (\tilde{q}(s)) of users and the number (qₙ(s)) of users in the new population thus generated who connected to the site (s) during the time period (T), is determined; the iterations being continued until the said difference is less than a given threshold, the population generated during the last iteration being considered to be representative of the behaviour of the said set of users.

4. Method according to claim 3, characterised in that the step consisting of determining the number of users (N(s)) who connected to each site or part of site (s) also comprises means of determining the total number of users (N) and the total number of users in the reference population (Q) who connected to the said site or part of site (s) during the given time period (T).

5. Method according to claim 4, characterised in that it also includes before the step to determine the theoretical number (\tilde{q}(s)) of users on each site (s) a step for defining the representativeness ratio \tilde{R} for the representative population to be generated, the said theoretical number (\tilde{q}(s)) of users being determined for each site or part of site (s) such that the ratio between the theoretical number of users and the total number of users (N(s)) who connected to the site (s) during the given time period T should be uniform for all sites of interest and should be equal to the representativeness ratio (\tilde{R}).

6. Method according to claim 5, characterised in that the new population generated during each iteration is a sub-population of the reference population, the size of which corresponds to the said representativeness ratio (\tilde{R}) with regard to the said total number of users (N), obtained by random drawing of users in the reference population in which the probability of drawing each user in the reference population is equal to the weighting associated with him, each Internet user thus drawn being counted in full in the generated population.

7. Method according to claim 5, characterised in that during each iteration, the new generated population is a population with exactly the same size as the reference population in which the weight of each Internet user is equal to the weighting associated with him.

8. Method according to claim 7, characterised in that in iteration rank n, the number of users (qₙ(s)) in the generated population who connected to site (s) during a given time period (T) is equal to the sum of weightings associated with each of the users in the reference population who actually connected the site (s) during a given time period (T).

9. Method according to claim 6 characterised in that in iteration rank n, the difference measurement is determined by calculating the variance vₙ on all sites of interest using
$${v}_{n} = {\sum }_{s} {( {q}_{n} ( s ) - \tilde{q} ( s ) )}^{2} ,$$
where \tilde{q}(s) is the theoretical number of users for the site s and qₙ(s) is the number of users in the population generated in iteration rank n who connected to the site s during the time period considered.

10. Method according to claim 3, characterised in that in each iteration, the weighting associated with a user in the reference population is increased if the user is connected for a given time period to sites for which the number of users (q(s)) in the reference population who connected to it is less than the theoretical number \tilde{q}(s), otherwise the weighting is reduced.

11. Method according to claim 10, characterised in that the weighting pₙ(i) associated with user i in the reference population, in rank n of the iteration, is then determined as described in the following equations:
$${p}_{n} ( i ) = {P}_{n - 1} ( i ) \frac{1}{1 + \frac{B ( i )}{{S}_{i}}} if B ( i ) \geq 0 or {P}_{n} ( i ) = {p}_{n - 1} ( i ) ( 1 - \frac{B ( i )}{{S}_{i}} ) if B ( i ) 0 ,$$
where
pₙ₋₁(i) is the weighting associated with qualified Internet user i in iteration rank n−1;
Sᵢ is the number of sites visited by Internet user i during the time period considered,
and
$$B ( i ) = {\sum }_{s ( i )} b ( s ) ,$$
where s(i) represents sites visited by Internet user i during the period considered, and
$$b ( s ) = \frac{{q}_{n} ( s )}{\tilde{q} ( s )} - 1 if q ( s ) \geq \tilde{q} ( s ) or b ( s ) = 1 - \frac{\tilde{q} ( s )}{{q}_{n} ( s )} if q ( s ) < \tilde{q} ( s ) ,$$
where q(s) is the number of users in the reference population who connected to the site (s) during the period considered, \tilde{q}(s) is the theoretical number of users for the site s and qₙ(s) is the number of users in the generated population in iteration rank n who connected to the site (s) during the period considered.

12. Method according to claim 3, characterised in that for the first iteration, the same weighting is associated with each user in the reference population.

13. Method according to claim 1, characterised in that it includes a preliminary step to filter traffic data collected by the traffic analysis system, to only consider data related to all users for whom a population representative of the behaviour needs to be generated.

14. Method for determining the profile of a user of a communication network, characterised in that it comprises a step to generate a representative population starting from a reference population using the method according to any one of the previous claims.

15. System (100) for generating a population of users of a communication network (200) representative of the behaviour of a set of network users starting from a reference population composed of known network users, characterised in that it comprises:
a server (101) that generates a representative population is connected to the network and includes processing means connected to a database (102) listing known users in the reference population;
a system (600) analysing traffic on sites of interest, connected to the network (200) and capable of determining the total number of users (N(s)) who connected to the said site or part of site (s) during a given time period (T), for each site or part of site (s) among all sites (300) of interest (301, 302, 303) accessible through the network, and discriminating which of these users are members of the reference population,
in which the processing means are capable of:
for each site or part of site (s), generating a theoretical number of users (\tilde{q}(s)) such that the ratio between the theoretical number of users \tilde{q}(s) and the total number of users (N(s)) who connected to the said site during the given time period (T) is uniform on all sites of interest;
generating a population of known network users starting from the reference population so as to minimise the difference between the said theoretical number of users \tilde{q}(s) and the number of users (qₙ(s)) in the generated population who connected to the site (s) during the time period (T), for all sites or parts of site (s).

16. System for profiling a user of a communication network, characterised in that it includes a system for generating a representative population according to the previous claim.

17. Method according to claim 8, characterised in that in iteration rank n, the difference measurement is determined by calculating the variance vₙ on all sites of interest using
$${v}_{n} = {\sum }_{s} {( {q}_{n} ( s ) - \tilde{q} ( s ) )}^{2} ,$$
where \tilde{q}(s) is the theoretical number of users for the site s and qₙ(s) is the number of users in the population generated in iteration rank n who connected to the site s during the time period considered.
